(19) United States
(12) Patent Application Publication
(10) Pub. No.: US 2008/0140294 A1
(43) Pub. Date: Jun. 12, 2008

(54) Accelerator pedal system

(75) Inventor: Hangil Park, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/701,162

(22) Filed: Jan. 31, 2007

(30) Foreign Application Priority Data
Dec. 8, 2006 (KR) 10-2006-0124906

(51) Int. Cl. B60K 31/00; B60K 31/02

(52) U.S. Cl. 701/93

(57) ABSTRACT

A reaction force of an accelerator pedal is controlled by an accelerator pedal system comprising: a vehicle speed sensor; an accelerator pedal; a switch that generates a signal corresponding to a speed limit and a selected mode; an engine management system that receives a signal from the vehicle speed sensor and the switch; an accelerator pedal position sensor that detects an operating position of the accelerator pedal and generates a corresponding signal; a pedal control unit that receives a vehicle speed signal and a switch signal from the engine management system, and outputs a control signal when a vehicle speed exceeds at least one of the speed limits; and a reaction device that in response to the control signal of the pedal control unit, generates a reaction force depending on the selected mode and applies the generated reaction force to the accelerator pedal.

### CROSS-REFERENCE TO RELATED APPLICATION

This application claims priority to and the benefit of Korean Patent Application No. 10-2006-0124906 filed on Dec. 08, 2006, the entire contents of which are incorporated herein by reference.

### BACKGROUND OF THE INVENTION

(a) Field of the Invention

The present invention relates to an accelerator pedal system. More particularly, the present invention relates to an accelerator pedal system that when a vehicle speed exceeds a predetermined limit speed, can warn a driver by producing a change in a reaction force of an accelerator pedal.

(b) Background Art

Typically, an accelerator pedal system is provided in a vehicle, and an accelerator pedal is pressed in order to increase a vehicle speed.

According to a conventional accelerator pedal system, the accelerator pedal operated by a foot of a driver is connected with a throttle valve by a cable, such that an opening of the throttle valve may be changed by a position change of the accelerator pedal.

Alternatively, an actuator electrically coupled with an accelerator pedal is employed such that the opening of the throttle valve may be changed by the actuator.

That is, according to such a conventional scheme, only the opening of the throttle valve is passively changed by the operation of the accelerator pedal.

Recently, a warning system has been suggested such that when a dangerous situation is detected or when a vehicle speed exceeds a predetermined speed limit, a driver can be warned of such a situation by feeling a change of a reaction force of the accelerator pedal.

According to such a system, typically, a motor is employed in order to produce a reaction force of the accelerator pedal.

However, it requires a complicated structure and produces a low performing efficiency.

Furthermore, an output torque of the motor should be changed in order to deliver various levels of the reaction force to the accelerator pedal, and this increases an overall load of the motor, thereby deteriorating durability of the motor.

For these reasons, it is hard to commercialize accelerator pedal systems with such driver-warning function without the expense of very high costs and low durability.

The above information disclosed in this Background section is only for enhancement of understanding of the background of the invention and therefore it may contain information that does not form the prior art that is already known in this country to a person of ordinary skills in the art.

### SUMMARY OF THE INVENTION

The present invention has been made in an effort to provide an accelerator pedal system that can warn a driver of a vehicle speed exceeding a predetermined speed limit with improved durability and for less production costs.

An accelerator pedal system according to an exemplary embodiment of the present invention controls a reaction force of an accelerator pedal. The accelerator pedal system comprises: a vehicle speed sensor; an accelerator pedal rotatable with respect to a vehicle body; a switch that generates a signal corresponding to at lease one speed limit and a selected mode among a plurality of predetermined modes; an engine management system that receives a signal from the vehicle speed sensor and the switch; an accelerator pedal position sensor that detects an operating position of the accelerator pedal and generates a corresponding signal; a pedal control unit that receives a vehicle speed signal and a switch signal from the engine management system, and outputs a control signal when a vehicle speed exceeds at least one of the speed limits; and a reaction device that, in response to the control signal of the pedal control unit, generates a reaction force depending on the selected mode and applies the generated reaction force to the accelerator pedal.

In a preferred embodiment, the plurality of predetermined modes may comprise: a first mode where a first reaction force is applied to the accelerator pedal; a second mode where a second reaction force is applied to the accelerator pedal; and a third mode where a third reaction force is applied to the accelerator pedal, wherein levels of the first, second, and third reaction forces are formed such that the first reaction force is greater than the second reaction force and the second reaction force is greater than the third reaction force.

Preferably, the reaction device may comprise: an actuator that operates in response to a signal from the pedal control unit; an operating member that is designed to be able to horizontally move by the operation of the actuator and vertically move by the accelerator pedal; an elastic member unit that is arranged so as to selectively apply the first, second, or third reaction force to the operating member; and a main elastic member that returns the operating member.

The elastic member unit may suitably comprise first, second, and third elastic members disposed below the operating members. The first reaction force may be generated by the first, second, and third elastic members. The second reaction force may be generated by the first and second elastic members. The third reaction force may be generated by the first elastic member.

Preferably, the actuator may comprise: a plunger connected with the operating member; and a subsidiary elastic member that returns the plunger.

The reaction device may further comprise a cable interconnecting the actuator and the operating member.

The actuator may be formed as a motor or an electromagnet.

### BRIEF DESCRIPTION OF THE DRAWINGS

FIG. 1 is a block diagram showing an accelerator pedal system according to an exemplary embodiment of the present invention.

FIG. 2 illustrates an accelerator pedal system according to an exemplary embodiment of the present invention.

FIG. 3 illustrates an accelerator pedal system according to an exemplary embodiment of the present invention, showing that an actuator can be located at various positions.

FIG. 4 to FIG. 6 illustrate operation of an accelerator pedal system according to an exemplary embodiment of the present invention.

Reference numerals set forth in the Drawings includes reference to the following elements as further discussed below:

101: switch

103: vehicle speed sensor

105: engine management system

107: accelerator pedal position sensor

109: pedal control unit

111: reaction device

200: accelerator pedal

401: actuator

201: operating member

203: rod

205: main elastic member

210: elastic member unit

250: vehicle body

### DETAILED DESCRIPTION

An exemplary embodiment of the present invention will hereinafter be described in detail with reference to the accompanying drawings.

The term “reaction force” used herein denotes a force that acts on an accelerator pedal to its home position. In other words, it refers to a force that pushes an accelerator pedal in a direction opposite to a direction in which the accelerator pedal is moved in order to accelerate a vehicle.

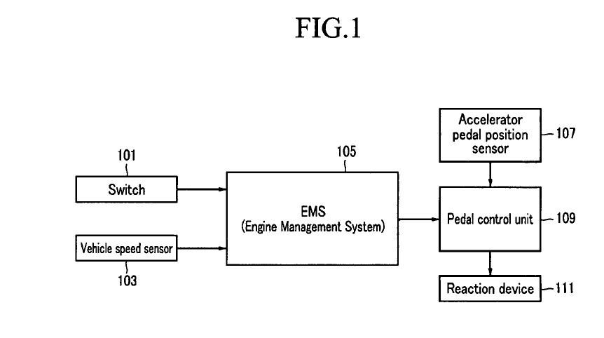

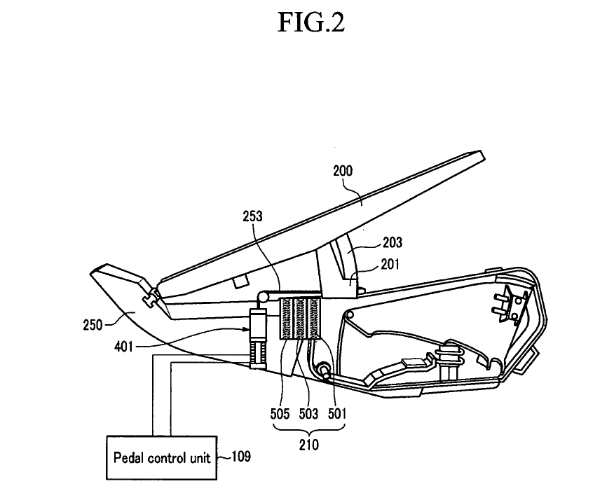

FIG. 1 is a block diagram showing an accelerator pedal system according to an exemplary embodiment of the present invention. FIG. 2 illustrates an accelerator pedal system according to an exemplary embodiment of the present invention.

As shown in FIG. 1 and FIG. 2, in order to control a reaction force of the accelerator pedal, the accelerator pedal system according to an exemplary embodiment of the present invention comprises a vehicle speed sensor 103, an accelerator pedal 200, a switch 101, an engine management system (EMS) 105, an accelerator pedal position sensor 107, a pedal control unit 109, and a reaction device 111.

The accelerator pedal 200 can rotate with respect to a vehicle body 250, and moves a rod 203 so as to open or close a throttle valve (not shown).

The operation of the throttle valve by the operation of the rod 203 may be realized in a various schemes that are obvious to a person of ordinary skills in the art.

The switch 101 generates a signal corresponding to at lease one speed limit and a selected mode among a plurality of predetermined modes. The engine management system 105 receives a signal from the vehicle speed sensor 103 and the switch 101.

The accelerator pedal position sensor 107 detects an operating position of the accelerator pedal 200, and generates a corresponding signal.

The pedal control unit 109 receives a vehicle speed signal and a switch signal of the switch 101 from the engine management system 105. When the vehicle speed exceeds the speed limit, the pedal control unit 109 outputs a control signal.

When the pedal control unit 109 outputs the control signal, the reaction device 111 receives the control signal and controls the accelerator pedal 200 such that the accelerator pedal 200 may be operated according to the selected mode. That is, in response to the control signal of the pedal control unit 109, the reaction device 111 generates a reaction force depending on the selected mode and applies the generated reaction force to the accelerator pedal 200.

That is, the switch 101 enables at least one of the speed limits and a desired mode among a plurality of modes to be selected.

The speed limit implies a predetermined value that is regarded to be dangerous, and such a speed limit may be set by a person of an ordinary skills in the art.

The plurality of modes imply ways of warning the driver when the vehicle speed exceeds the speed limit. According to an exemplary embodiment of the present invention, they imply different controlling of pedal reaction force of the accelerator pedal 200.

According to an exemplary embodiment of the present invention, the plurality of predetermined mode comprise first, second, and third modes.

In the first mode, the reaction device 111 operates such that a first reaction force is applied to the accelerator pedal 200. In the second mode, the reaction device 111 operates such that a second reaction force is applied to the accelerator pedal 200. In the third mode, the reaction device 111 operates such that a third reaction force is applied to the accelerator pedal 200.

Levels of the reaction forces can be designed so as to satisfy the following condition: the first reaction force>the second reaction force>the third reaction force.

Since the switch 101 is operated by a driver, the desired mode can also be selected by the driver.

The engine management system 105 may be realized by a typical engine management system of a conventional vehicle. According to an exemplary embodiment of the present invention, the engine management system 105 receives signals from the vehicle speed sensor 103 and the switch 101, and sends the signals to the pedal control unit 109.

The accelerator pedal position sensor 107 detects a pedal position of the accelerator pedal 200, and sends the detected pedal position to the pedal control unit 109.

According to an exemplary embodiment of the present invention, when the signal from the accelerator pedal position sensor 107 corresponds to a deep operation (e.g., over 85% of stroke) of the accelerator pedal 200, or when the switch 101 is turned off, the accelerator pedal system suspends its operation.

The pedal control unit 109 can be realized by at least one of microprocessors executing a predetermined program, and the predetermined program can be programmed to include a set of instructions to perform steps in a method according to an exemplary embodiment of the present invention, which will later be described in more detail.

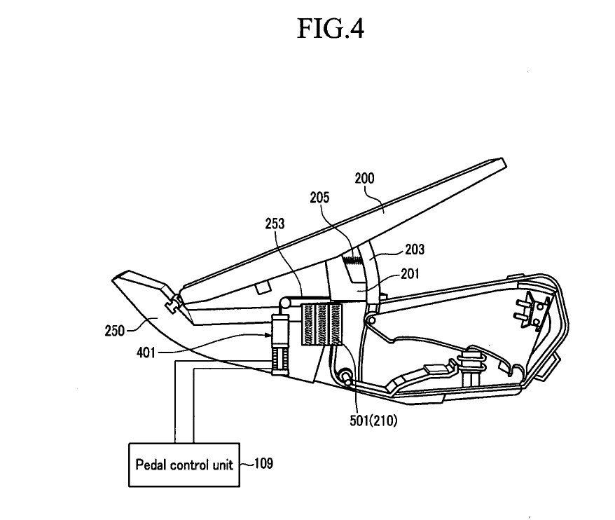

The reaction device 111 may preferably comprise an actuator 401, an operating member 201, an elastic member unit 210, and a main elastic member 205 (refer to FIG. 4).

The actuator 401 operates in response to a signal from the pedal control unit 109, and the operating member 201 is operated by the actuator 401 so as to selectively generate the first, second, or third reaction force.

The main elastic member 205 is arranged so as to return the operating member 201 to its home position.

The actuator 401 may be fixed to a stationary position of a vehicle such as a vehicle body 250.

As shown in FIG. 2, the operating member 201 can horizontally move by the operation of the actuator 401, and can vertically move by the accelerator pedal 200.

The elastic member unit 210 is arranged so as to selectively apply the first, second, or third reaction force to the operating member 201.

Application of the reaction forces will be later described in detail.

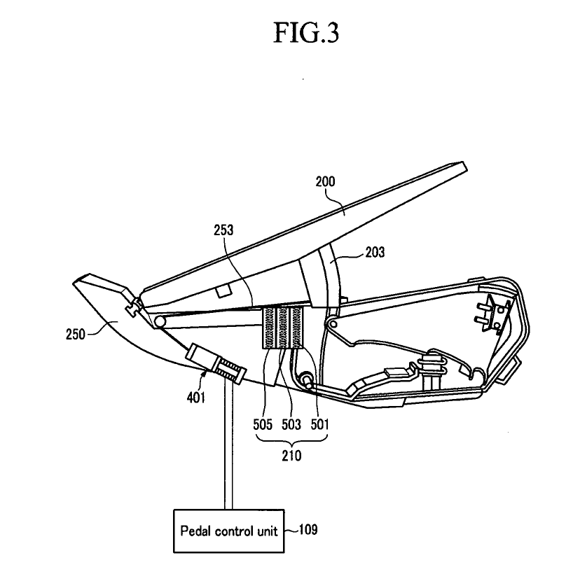

FIG. 3 illustrates an accelerator pedal system according to an exemplary embodiment of the present invention, showing that an actuator can be located at various positions. FIG. 4 to FIG. 6 illustrate an operation of an accelerator pedal system according to an exemplary embodiment of the present invention.

The elastic member unit 210 may preferably comprise the first, second, and third elastic members 501, 503, and 505 that are arranged in the operating member 201.

The first reaction force is generated by cooperative operation of the first, second, and third elastic members 501, 502, and 503. The second reaction force is generated by the first and second elastic members 501 and 503. The third reaction force is generated solely by the first elastic member 501.

The operating member 201 is arranged such that it may differently press the elastic member unit 210 depending on its position.

That is, the operating member 201 may be positioned either above the first elastic member 501, above the first and second elastic members 501 and 503, or above the first, second, and third elastic members 501, 502, and 503.

The reaction device 111 may further comprise a cable 253 connecting the actuator 401 and the operating member 201.

When the actuator 401 operates to draw the cable 253, the operating member 201 is moved to the left in the drawing by the cable 253.

The actuator 401 may be realized as a motor or an electromagnet, and the moving distance of the operating member 201 may be controlled by controlling a current level applied to the actuator 401 by the pedal control unit 109.

As shown in FIG. 3, the actuator 401 may be mounted to the vehicle body 250 in a substantially horizontal direction.

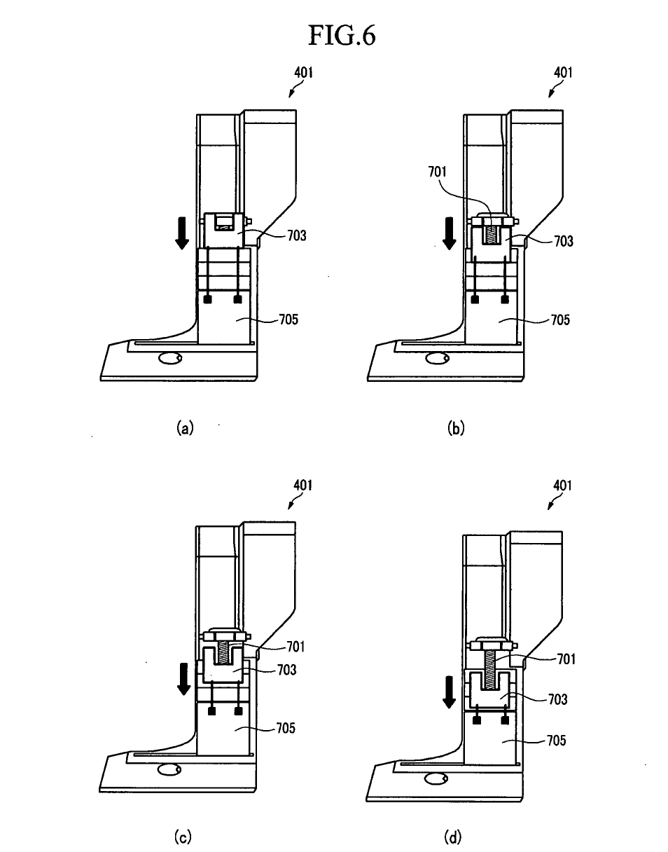

The actuator 401 may preferably comprise a subsidiary elastic member 701 (refer to FIG. 6) so as to generate the first, second, and third reaction forces.

As shown in FIG. 6, when the actuator 401 is realized as an electromagnet, a plunger 703 is moved by a solenoid 705 such that the first, second, and third reaction forces may be generated.

Then, the subsidiary elastic member 701 returns the plunger 703 of the actuator 401 to its home position.

Hereinafter, operation of the accelerator pedal system according to an exemplary embodiment of the present invention will be described in detail with reference to FIG. 4 to FIG. 6.

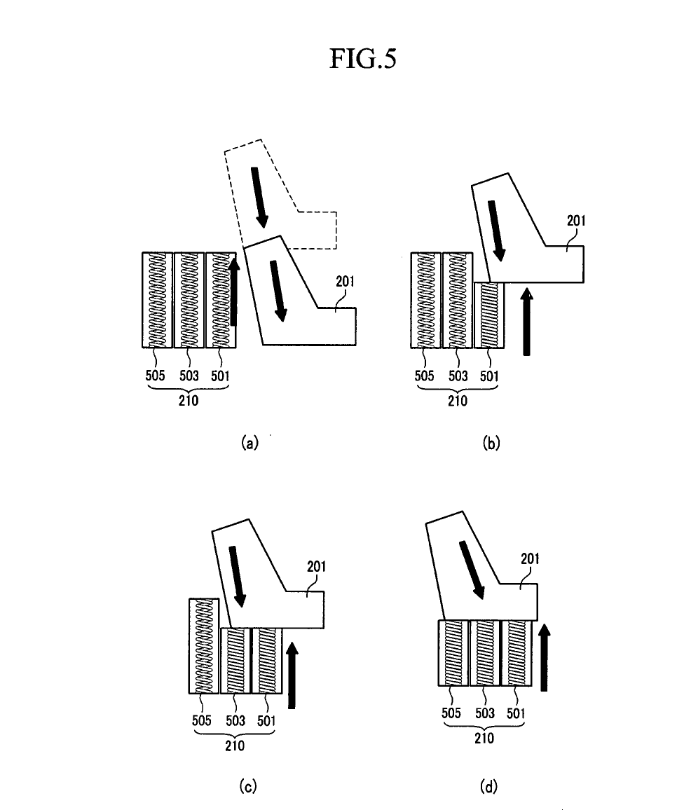

FIG. 4 illustrates the exemplary accelerator pedal system when the first reaction force is applied to the operating member 201. FIG. 5(a) and FIG. 6(a) illustrate the case that the reaction device 111 is not operating. FIG. 5(b) and FIG. 6(b) illustrate the case that the reaction device 111 is operating in the third mode. FIG. 5(c) and FIG. 6(c) illustrate the case that the reaction device 111 is operating in the second mode. FIG. 5(d) and FIG. 6(d) illustrate the case that the reaction device 111 is operating in the first mode.

As shown in FIG. 4, FIG. 5(a), and FIG. 6(a), when the reaction device 111 is not operating, the operating member 201 does not affect the operation of the accelerator pedal 200.

That is, the operating member 201 and the elastic member unit 210 do not interact with each other even if the accelerator pedal 200 is operated.

When a predetermined dangerous situation is detected, or when the vehicle speed exceeds a speed limit in a selected mode, the engine management system 105 receives a corresponding signal and outputs it to the pedal control unit 109.

The speed limit may be one that has been inputted by a radar sensor or a navigation system installed in the vehicle.

The predetermined dangerous situation may be detected by, e.g., the vehicle navigation system or a front monitoring camera, and such a dangerous situation may be appropriately set as a design choice by a person of an ordinary skills in the art.

When the pedal control receives the corresponding signal, the pedal control unit 109 operates the reaction device 111.

When the reaction device 111 is operated, the actuator 401 draws the operating member 201 to the left in the drawing by the cable 253.

As described above, the moving distance of the operating member 201 depends on the current level applied to the actuator 401 by the pedal control unit 109.

That is, when the first reaction force is required to be generated in the first mode, the operating member 201 is drawn leftmost so as to be capable of pressing the first, second, and third elastic members 501, 502, and 503 as shown in FIG. 5(d).

When the second reaction force is required to be generated in the second mode, the operating member 201 is drawn left by an intermediate distance so as to be capable of pressing the first and second elastic members 501 and 502 as shown in FIG. 5(c).

When the third reaction force is required to be generated in the third mode, the operating member 201 is drawn left by a small distance so as to be capable of pressing the first elastic member 501 as shown in FIG. 5(b).

When a driver presses the accelerator pedal 200 after the operating member 201 is drawn to a position corresponding to the selected mode, the operating member 201 is accordingly pressed down and thus the first, second, or third reaction force is selectively generated depending on the moved position of the operating member 201.

That is, according to an exemplary embodiment of the present invention, since a plurality of reaction forces can be generated, a plurality of speed limits may be set and exceeding of the speed limits can be warned to a driver by different reaction forces on the accelerator pedal 200.

Therefore, the driver can feel the change of the reaction force of the accelerator pedal 200 and can notice the warning of dangerous situation or exceeding of speed limits.

According to an exemplary embodiment of the present invention, when the driver presses the accelerator pedal 200 more than a kick-down point (for example, more than 85% of entire stroke of the accelerator pedal 200), or when the switch 101 is turned off, the accelerator pedal system is turned off.

When the accelerator pedal system is turned off, the operating member 201 of the reaction device 111 returns to its home position as shown in FIG. 2.

That is, according to an exemplary embodiment of the present invention, the warning function can be turned off and a normal reaction force can be applied to the accelerator pedal 200, as well as a plurality of warning modes, i.e., the first, second, and third modes are realized.

As described above, the first, second, and third reaction forces are generated depending on the position of the operating member 200 that is designed to be moved by the plunger 703 operated by the solenoid 705.

When the accelerator pedal system according to an exemplary embodiment of the present invention is turned off, the plunger 703 is returned to its home position by the subsidiary elastic member 701.

According to an exemplary embodiment of the present invention, a dangerous situation or a driver's over-speeding situation can be warned to the driver. Therefore, driving safety can be enhanced.

The reaction forces on the accelerator pedal are generated by simple mechanical scheme using elastic members, and thus reducing production costs and improving durability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An accelerator pedal system that controls a reaction force of an accelerator pedal, the accelerator pedal system comprising:
a vehicle speed sensor;
an accelerator pedal rotatable with respect to a vehicle body;
a switch that generates a signal corresponding to at lease one speed limit and a selected mode among a plurality of predetermined modes;
an engine management system that receives a signal from the vehicle speed sensor and the switch;
an accelerator pedal position sensor that detects an operating position of the accelerator pedal and generates a corresponding signal;
a pedal control unit that receives a vehicle speed signal and a switch signal from the engine management system, and outputs a control signal when a vehicle speed exceeds at least one of the speed limits; and
a reaction device that in response to the control signal of the pedal control unit, generates a reaction force depending on the selected mode and applies the generated reaction force to the accelerator pedal.

2. The accelerator pedal system of claim 1, wherein the plurality of predetermined modes comprise:
a first mode where a first reaction force is applied to the accelerator pedal;
a second mode where a second reaction force is applied to the accelerator pedal; and
a third mode where a third reaction force is applied to the accelerator pedal,
wherein levels of the first, second, and third reaction forces are formed such that the first reaction force is greater than the second reaction force and the second reaction force is greater than the third reaction force.

3. The accelerator pedal system of claim 2, wherein the reaction device comprises:
an actuator that operates in response to a signal from the pedal control unit;
an operating member that is designed to be able to horizontally move by the operation of the actuator and vertically move by the accelerator pedal;
an elastic member unit that is arranged so as to selectively apply the first, second, or third reaction force to the operating member; and
a main elastic member that returns the operating member.

4. The accelerator pedal system of claim 3, wherein:
the elastic member unit comprises first, second, and third elastic members disposed below the operating members;
the first reaction force is generated by the first, second, and third elastic members;
the second reaction force is generated by the first and second elastic members; and
the third reaction force is generated by the first elastic member.

5. The accelerator pedal system of claim 3, wherein the actuator comprises:
a plunger connected with the operating member; and
a subsidiary elastic member that returns the plunger.

6. The accelerator pedal system of claim 3, wherein the reaction device further comprises a cable interconnecting the actuator and the operating member.

7. The accelerator pedal system of claim 3, wherein the actuator is formed as a motor or an electromagnet.
